(19) United States
(12) Patent Application Publication
(10) Pub. No.: US 2006/0048455 A1
(43) Pub. Date: Mar. 9, 2006

(54) Polishing composition and polishing method using the same

(76) Inventors: Junichi Hirano, Nagoya-shi (JP); Yasushi Matsunami, Gifu-shi (JP); Noritaka Yokomichi, Ichinomiya-shi (JP)

Correspondence Address: VIDAS, ARRETT & STEINKRAUS, P.A., 6109 BLUE CIRCLE DRIVE, SUITE 2000, MINNETONKA, MN, 55343-9185, US

(21) Appl. No.: 11/222,403

(22) Filed: Sep. 8, 2005

(30) Foreign Application Priority Data
Sep. 9, 2004 (JP) 2004-262763

(51) Int. Cl. B24D 3/02; C09K 3/14

(52) U.S. Cl. 51/308

(57) ABSTRACT

A polishing composition includes an abrasive, at least one acid selected from the group consisting of orthophosphoric acid, diphosphoric acid, polyphosphoric acid, metaphosphoric acid, hexametaphosphoric acid, methyl acid phosphate, ethyl acid phosphate, ethyl glycol acid phosphate, isopropyl acid phosphate, phytic acid, and 1-hydroxyethylidene-1,1-diphosphonic acid; at least one salt selected from the group consisting of sodium salts, potassium salts, and lithium salts of an acid selected from orthophosphoric acid, diphosphoric acid, polyphosphoric acid, metaphosphoric acid, hexametaphosphoric acid, methyl acid phosphate, ethyl acid phosphate, ethyl glycol acid phosphate, isopropyl acid phosphate, phytic acid, and 1-hydroxyethylidene-1,1-diphosphonic acid; an oxidizing agent; and water.

### BACKGROUND OF THE INVENTION

The present invention relates to a polishing composition for use in polishing substrates for magnetic disks and the like, and to a method for polishing substrates for magnetic disks and the like using the polishing composition.

With respect to a magnetic disk for use in a hard disk serving as a memory device for a computer, there have been strong demands for high storage density. Therefore, a substrate for a magnetic disk is required to have superior surface characteristics, for example, few surface defects such as corrosion or scratches.

Japanese Laid-Open Patent Publication No. 2002-327170 discloses a polishing composition improved so as to satisfy such a requirement for a substrate for a magnetic disk. The polishing composition contains an organic phosphonic acid. When a substrate for a magnetic disk is polished using the polishing composition, a protective film is formed on the surface of the substrate by the action of the organic phosphonic acid and therefore, generation of corrosion and scratches on the surface is suppressed.

However, since the protective film formation action of organic phosphonic acid is not so strong, the degree of suppression of corrosion and scratches is not so high. Therefore, there is yet room for improvement in the polishing composition.

### SUMMARY OF THE INVENTION

Accordingly, an objective of the present invention is to provide a polishing composition more suitable for use in polishing a substrate for a magnetic disk, and another objective of the present invention is to provide a method for polishing an object by using the polishing composition.

To achieve the foregoing and other objectives and in accordance with the purpose of the present invention, a polishing composition is provided. The polishing composition includes an abrasive containing a silicon oxide; at least one acid selected from the group consisting of orthophosphoric acid, diphosphoric acid, polyphosphoric acid, metaphosphoric acid, hexametaphosphoric acid, methyl acid phosphate, ethyl acid phosphate, ethyl glycol acid phosphate, isopropyl acid phosphate, phytic acid, and 1-hydroxyethylidene-1,1-diphosphonic acid; at least one salt selected from the group consisting of sodium salts, potassium salts, and lithium salts of an acid selected from orthophosphoric acid, diphosphoric acid, polyphosphoric acid, metaphosphoric acid, hexametaphosphoric acid, methyl acid phosphate, ethyl acid phosphate, ethyl glycol acid phosphate, isopropyl acid phosphate, phytic acid, and 1-hydroxyethylidene-1,1-diphosphonic acid; an oxidizing agent; and water.

The present invention also provides a method for polishing an object. The method includes preparing the above polishing composition and polishing the object using the prepared polishing composition.

Other aspects and advantages of the invention will become apparent from the following description illustrating by way of example the principles of the invention.

### DETAILED DESCRIPTION OF THE PREFERRED EMBODIMENTS

An embodiment of the present invention will now be described. A polishing composition according to this embodiment contains an abrasive, at least one specific acid, at least one specific salt, an oxidizing agent, and water.

The polishing composition is used in applications for polishing surfaces of substrates for magnetic disks. In other words, the polishing composition is used in applications for polishing substrates for magnetic disks as semi-finished products to obtain substrates for magnetic disks as polished products. The polishing composition is preferably used in the final polishing step of a plurality of polishing steps generally conducted in processing a substrate for a magnetic disk. A surface of a substrate is polished using the polishing composition, for example, by placing a polishing member such as a polishing pad in contact with the substrate surface, and sliding either the substrate or the polishing member while feeding the polishing composition into the contact portion.

The abrasive in the polishing composition plays the role of mechanically polishing substrate surfaces.

While an abrasive to be contained in the polishing composition contains at least silicon oxide, the abrasive preferably contains silicon dioxide, and more preferably is silicon dioxide. Substrates polished using a polishing composition containing silicon dioxide as an abrasive have superior surface characteristics than those of substrates polished using a polishing composition containing other abrasives. Silicon dioxide to be contained in the polishing composition may be any of fumed silica, colloidal silica, and precipitated silica, and preferably is colloidal silica. A polishing composition containing colloidal silica as an abrasive is superior in stability than polishing compositions containing other silicon dioxide as an abrasive. Substrates polished using a polishing composition containing colloidal silica as an abrasive have superior surface characteristics having less defects such as scratches.

An abrasive having too small an average particle size is not so high in ability to polish substrate surfaces. Therefore, in view of accelerating polishing of substrate surfaces with an abrasive, the average particle size of an abrasive to be contained in the polishing composition is preferably 0.005 μm or more, and more preferably 0.01 μm or more. Meanwhile, when an abrasive has too large an average particle size, there is a risk of decreasing the dispersion stability of the polishing composition, causing the abrasive to precipitate, or a risk of generating scratches on substrate surfaces to be polished, or roughening the substrate surfaces. Therefore, in view of inhibiting the dispersion stability of the polishing composition from decreasing, and ensuring an improvement in the surface characteristics of the substrates, the average particle size of an abrasive to be polished in the polishing composition is preferably 0.5 μm or less, and more preferably 0.3 μm or less. The average particle size of an abrasive is determined from the specific surface area of the abrasive measured by a BET method.

A polishing composition containing too small an amount of an abrasive is not so high in polishing ability. Therefore, in view of ensuring an improvement in polishing ability of the polishing composition, the content of the abrasive in the polishing composition is preferably 0.01% by mass or more, and more preferably 0.1% by mass or more. Meanwhile, when the polishing composition contains a large amount of an abrasive, there is a risk of decreasing the dispersion stability of the polishing composition, causing the abrasive to precipitate or agglomerate. Therefore, in view of inhibiting the dispersion stability of the polishing composition from decreasing, the content of the abrasive in the polishing composition is preferably 40% by mass or less, and more preferably 10% by mass or less.

The at least one specific acid in the polishing composition plays the role of chemically polishing substrate surfaces and the role of increasing acidity of the polishing composition to accelerate oxidization of the substrate surfaces by the oxidizing agent, contributing to an improvement of polishing ability of the polishing composition.

While at least one specific acid to be contained in the polishing composition is selected from the group consisting of orthophosphoric acid, diphosphoric acid (also known as pyrophosphoric acid), polyphosphoric acid, metaphosphoric acid, hexametaphosphoric acid, methyl acid phosphate (also known as methyl phosphoric acid), ethyl acid phosphate (also known as ethyl phosphoric acid), ethyl glycol acid phosphate, isopropyl acid phosphate, phytic acid (also known as inositol hexaphosphoric acid), and 1-hydroxyethylidene-1,1-diphosphonic acid (abbreviated as HEDP), it is preferably orthophosphoric acid or polyphosphoric acid. Orthophosphoric acid and polyphosphoric acid are useful since they have a particularly strong action for enhancing polishing ability of the polishing composition.

Polyphosphoric acid is a linear polymeric phosphoric acid produced by dehydration condensation of orthophosphoric acids and is represented by the chemical formula: Hₙ₊₂PₙO₃ₙ₊₁, wherein n represents an integer of 2 to 4. Polyphosphoric acid to be contained in the polishing composition may be a mixture of linear polymeric phosphoric acids that are different from each other in the number of n. That is, polyphosphoric acid to be contained in the polishing composition may be a mixture of at least two compounds selected from diphosphoric acid, triphosphoric acid and tetraphosphoric acid. A condensation ratio of polyphosphoric acid to be contained in the polishing composition, that is, the ratio of the mass of orthophosphoric acid produced by hydrolysis of the polyphosphoric acid in the polishing composition with respect to the mass of the polyphosphoric acid may be 105% or 116%, or may be values other than those.

A polishing composition containing too small an amount of a specific acid is not so high in polishing ability. Therefore, in view of ensuring an improvement in polishing ability of the polishing composition, the content of the acid in the polishing composition is preferably 0.01% by mass or more, and more preferably 1% by mass or more. Meanwhile, when the polishing composition contains a large amount of a specific acid, there is a risk of roughening substrate surfaces to be polished, since the corrosive action of the polishing composition becomes too strong. Therefore, in view of inhibiting substrate surfaces to be polished from roughening, the content of the acid in the polishing composition is 40% by mass or less, and more preferably 20% by mass or less.

The at least one specific salt in the polishing composition has an action for forming a passive film having scratch resistance and corrosion resistance on substrate surfaces to be polished, so that it contributes to an improvement of surface characteristics of the substrates.

While at least one specific salt to be contained in the polishing composition is selected from the group consisting of sodium salts, potassium salts, and lithium salts of an acid selected from orthophosphoric acid, diphosphoric acid, polyphosphoric acid, metaphosphoric acid, hexametaphosphoric acid, methyl acid phosphate, ethyl acid phosphate, ethyl glycol acid phosphate, isopropyl acid phosphate, phytic acid, and 1-hydroxyethylidene-1,1-diphosphonic acid, it is preferably a sodium salt or a potassium salt of the above acid. Sodium and potassium salts of the above acid have a particularly strong action for forming a passive film on substrate surfaces to be polished.

A polishing composition containing too small an amount of a specific salt does not improve the surface characteristics of substrates to be polished enough. Therefore, in view of ensuring an improvement in the surface characteristics of the substrates, the content of the salt in the polishing composition is preferably 0.01% by mass or more, and more preferably 1% by mass or more. Meanwhile, when the polishing composition contains a large amount of a specific salt, there is a risk of decreasing dispersion stability of the polishing composition. Therefore, in view of inhibiting reduction of dispersion stability, the content of the salt in the polishing composition is 30% by mass or less, and more preferably 10% by mass or less.

The oxidizing agent in the polishing composition plays the role of accelerating mechanical polishing of substrate surfaces to be polished by an abrasive by oxidizing the substrate surfaces.

While an oxidizing agent to be contained in the polishing composition may contain any of hydrogen peroxide, nitric acid, potassium permanganate, sodium persulfate, perchloric acid, and periodate, it preferably contains hydrogen peroxide, and more preferably is hydrogen peroxide. Hydrogen peroxide is useful since it has particularly high ability to accelerate mechanical polishing of substrate surfaces to be polished.

A polishing composition containing too small an amount of an oxidizing agent is not so high in polishing ability, and has a risk of causing scratches. Therefore, in view of ensuring an improvement in polishing ability of the polishing composition and inhibiting the generation of scratches, the content of the oxidizing agent in the polishing composition is preferably 0.1% by mass or more, and more preferably 0.3% by mass or more. Meanwhile, when the polishing composition contains a large amount of an oxidizing agent, there is a risk of expansion in the material cost of the polishing composition. Therefore, in view of reducing the material cost, the content of the oxidizing agent in the polishing composition is 5% by mass or less, and more preferably 1% by mass or less.

The water in the polishing composition serves as a medium for dispersing or dissolving components other than water in the polishing composition. Water to be contained in the polishing composition may be industrial water, tap water, distilled water, or one obtained by filtering any of these, and preferably contains as little impurities as possible.

When the pH of the polishing composition is too low, the corrosive action of the polishing composition becomes too strong, having a risk of roughening substrate surfaces to be polished. Therefore, in view of inhibiting substrate surfaces to be polished from roughening, the pH of the polishing composition is preferably 0.5 or more, and more preferably 1 or more. Meanwhile, when the pH of the polishing composition is too high, there is a risk of lowering the polishing ability of the polishing composition. Therefore, in view of inhibiting the lowering of the polishing ability of the polishing composition, the pH of the polishing composition is preferably 5 or less, and more preferably 3 or less.

This embodiment includes the following advantages.

A polishing composition according to this embodiment contains at least one acid that contributes to an improvement of polishing ability of the polishing composition. Thus, the polishing composition, compared to the conventional polishing compositions, has greater ability to polish surfaces of substrates for magnetic disks at a high removal rate. In addition, the polishing composition contains at least one salt having an action for forming a scratch resistant and corrosion resistant passive film on the substrate surfaces. Thus, substrates polished using the polishing composition have superior surface characteristics compared to substrates polished using conventional polishing compositions. The present polishing composition is hence useful in polishing surfaces of substrates for magnetic disks.

The above-described embodiment may be modified in the following manner.

A polishing composition according to the above-described embodiment may further contain a polishing accelerator. A polishing accelerator to be contained in the polishing composition may contain at least one compound selected from the group consisting of citric acid, maleic acid, maleic anhydride, malic acid, glycolic acid, succinic acid, itaconic acid, malonic acid, iminodiacetic acid, gluconic acid, lactic acid, mandelic acid, tartaric acid, crotonic acid, nicotinic acid, acetic acid, adipic acid, glycine, alanine, histidine, formic acid, and oxalic acid. The polishing accelerator plays the role of chemically polishing substrate surfaces to be polished, contributing to an improvement of the polishing ability of the polishing composition.

When the polishing composition contains too small an amount of a polishing accelerator, polishing ability of the polishing composition is not improved enough. Therefore, in view of greatly improving polishing ability of the polishing composition, the content of the polishing accelerator in the polishing composition is preferably 0.01% by mass or more, and more preferably 1% by mass or more. Meanwhile, when the polishing composition contains a large amount of the polishing accelerator, the corrosive action of the polishing composition becomes too strong, having a risk of roughening substrate surfaces to be polished. Therefore, in view of inhibiting substrate surfaces to be polished from roughening, the content of the polishing accelerator is preferably 40% by mass or less, and more preferably 20% by mass or less.

A polishing composition according to the above-described embodiment may further contain a surfactant, corrosion inhibitor, antiseptic, rust-preventive agent, antifoaming agent, thickener and the like.

A polishing composition according to the above-described embodiment may be prepared by diluting with water an undiluted polishing composition.

A polishing composition according to the above-described embodiment may be used in applications for polishing a surface of an object other than substrates for magnetic disks.

The present invention will be described in more detail by referring to Examples and Comparative Examples.

In Examples 1 to 29, an abrasive, a acid, a salt, an oxidizing agent, and water were mixed, and to the mixture was added a polishing accelerator, if necessary, to prepare polishing compositions. The details for abrasives, acids, salts, oxidizing agents, and polishing accelerators used in Examples 1 to 29 are shown in Table 1.

In Comparative Examples 1 to 14, an abrasive and water were mixed, and to the mixture was added, if necessary, a acid, a salt, an oxidizing agent, or a polishing accelerator. The details for abrasives, acids, salts, oxidizing agents, and polishing accelerators used in Comparative Examples 1 to 14 are shown in Table 1.

The surface of a substrate for a magnetic disk was polished using each polishing composition of Examples 1 to 29 and Comparative Examples 1 to 14 under the following polishing conditions.

Polishing Conditions

Object to be polished: ten substrates for magnetic disks having a diameter of 3.5 inches (about 95 mm) provided with an electroless nickel-phosphorus plated layer, which have been preliminarily polished to have a value for surface roughness Ra of about 6 Å as measured by a scanning probe microscope “Nanoscope III” manufactured by Digital Instrument Co., Ltd.
Polishing machine: double-sided polishing machine “SFDL-9B” manufactured by SPEEDFAM Co., Ltd.
Polishing pad: “Belatrix N0058” manufactured by Kanebo, Ltd.
Polishing pressure: 7.8 kPa (=80 g/cm²)
Rotation speed of lower platen: 30 rpm
Feed rate of polishing composition: 40 mL/minute
Polishing time: 8 minutes

The difference in the weight of each magnetic disk substrate before and after polishing under the above-described polishing conditions, that is, the reduced weight of each substrate was measured, and polishing rate (stock removal rate) was calculated for each according to the equation: polishing rate [μm/minute]=reduced weight [g]/(substrate surface area [cm²]×nickel-phosphorus plating density [g/cm³]×polishing time [minute])×10⁴. Polishing ability of each polishing composition was evaluated based on the thus calculated polishing rate according to a four rank scale: excellent (1), good (2), acceptable (3), and poor (4). Specifically, a polishing rate of 0.10 or more was ranked excellent; 0.07 or more and less than 0.10 was ranked good; 0.04 or more and less than 0.07 was ranked acceptable; and less than 0.04 was ranked poor. The results of the evaluation are shown in the column entitled “Polishing rate” in Table 1.

The number of scratches on the surface and back surface in the half portion of the outer side of each polished substrate was measured by using an ultrafine defect visualizing macro-inspecting apparatus “MicroMax VMX2100” manufactured by VISION PSYTEC CO., LTD. Based on the average value of the number of scratches measured by each surface of five substrates, the surface characteristics of the polished substrate with each polishing composition were evaluated according to a four rank scale: excellent (1), good (2), acceptable (3), and poor (4). Specifically, when the average value of the number of scratches is less than 20, it was ranked excellent; when it was 20 or more and less than 50, ranked good; when it was 50 or more and less than 100, ranked acceptable; and when it was 100 or more, ranked poor. The evaluation results are shown in the column entitled “Scratches” in Table 1.

Substrates for magnetic disks before polishing were dipped in the polishing compositions of Examples 1 to 29 and Comparative Examples 1 to 14 all kept at 30° C. After three hours, the substrates were taken out of the polishing compositions and then washed with water and dried. The difference in weight of each substrate before and after dipping, that is, reduction in weight of each substrate caused by dipping was measured. Based on the average value of reduction in weight of two substrates for each polishing composition, the degree of corrosive action of each polishing composition was evaluated according to a four rank scale: excellent (1), good (2), acceptable (3), and poor (4). Specifically, when the average value of reduction in weight is less than 5 mg, it was ranked excellent; when it was 5 mg or more and less than 8 mg, ranked good; when it was 8 mg or more and less than 10 mg, ranked acceptable; and when it was 10 mg or more, ranked poor. The evaluation results are shown in the column entitled “Corrosiveness” in Table 1.

TABLE 1

| | | | | Oxidizing | | | | |
|---|---|---|---|---|---|---|---|---|
| | | | Salt | agent | Polishing | | | |
| | Abrasive | Acid | [mass | [mass | accelerator | | | |
| | [mass percentage] | [mass percentage] | percentage] | percentage] | [mass percentage] | Polishing rate | Scratches | Corrosiveness |
| Ex. 1 | colloidal silica*¹ | orthophosphoric acid | K₂HPO₄ | H₂O₂ | — | 2 | 2 | 1 |
| | 5.0% | 0.5% | 0.4% | 1.0% | | | | |
| Ex. 2 | colloidal silica*¹ | orthophosphoric acid | K₂HPO₄ | H₂O₂ | — | 1 | 1 | 1 |
| | 5.0% | 1.0% | 0.4% | 1.0% | | | | |
| Ex. 3 | colloidal silica*¹ | orthophosphoric acid | K₂HPO₄ | H₂O₂ | — | 1 | 1 | 2 |
| | 5.0% | 2.0% | 0.4% | 1.0% | | | | |
| Ex. 4 | colloidal silica*¹ | orthophosphoric acid | Na₂HPO₄ | H₂O₂ | — | 1 | 1 | 1 |
| | 5.0% | 1.0% | 0.4% | 1.0% | | | | |
| Ex. 5 | colloidal silica*¹ | orthophosphoric acid | KH₂PO₄ | H₂O₂ | — | 1 | 1 | 1 |
| | 5.0% | 1.0% | 0.4% | 1.0% | | | | |
| Ex. 6 | colloidal silica*¹ | orthophosphoric acid | K₂HPO₄ | H₂O₂ | — | 1 | 2 | 1 |
| | 5.0% | 1.0% | 0.1% | 1.0% | | | | |
| Ex. 7 | colloidal silica*¹ | orthophosphoric acid | K₂HPO₄ | H₂O₂ | — | 2 | 1 | 1 |
| | 5.0% | 1.0% | 1.0% | 1.0% | | | | |
| Ex. 8 | colloidal silica*¹ | orthophosphoric acid | K₂HPO₄ | H₂O₂ | — | 2 | 2 | 1 |
| | 5.0% | 1.0% | 0.4% | 0.3% | | | | |
| Ex. 9 | colloidal silica*¹ | orthophosphoric acid | K₂HPO₄ | H₂O₂ | — | 1 | 1 | 2 |
| | 5.0% | 1.0% | 0.4% | 3.0% | | | | |
| Ex. 10 | colloidal silica*² | orthophosphoric acid | K₂HPO₄ | H₂O₂ | — | 1 | 2 | 1 |
| | 5.0% | 1.0% | 0.4% | 1.0% | | | | |
| Ex. 11 | colloidal silica*³ | orthophosphoric acid | K₂HPO₄ | H₂O₂ | — | 2 | 1 | 1 |
| | 5.0% | 1.0% | 0.4% | 1.0% | | | | |
| Ex. 12 | colloidal silica*¹ | orthophosphoric acid | K₂HPO₄ | H₂O₂ | — | 1 | 2 | 1 |
| | 1.0% | 1.0% | 0.4% | 1.0% | | | | |
| Ex. 13 | colloidal silica*¹ | orthophosphoric acid | K₂HPO₄ | H₂O₂ | — | 1 | 2 | 1 |
| | 10.0% | 1.0% | 0.4% | 1.0% | | | | |
| Ex. 14 | colloidal silica*¹ | diphosphoric acid | K₂HPO₄ | H₂O₂ | — | 1 | 1 | 1 |
| | 5.0% | 1.0% | 0.4% | 1.0% | | | | |
| Ex. 15 | colloidal silica*¹ | polyphosphoric acid | K₂HPO₄ | H₂O₂ | — | 2 | 1 | 2 |
| | 5.0% | 1.0% | 0.4% | 1.0% | | | | |
| Ex. 16 | colloidal silica*¹ | metaphosphoric acid | K₂HPO₄ | H₂O₂ | — | 2 | 1 | 1 |
| | 5.0% | 1.0% | 6.4% | 1.0% | | | | |
| Ex. 17 | colloidal silica*¹ | hexametaphosphoric | K₂HPO₄ | H₂O₂ | — | 2 | 1 | 1 |
| | 5.0% | acid | 6.4% | 1.0% | | | | |
| | | 1.0% | | | | | | |
| Ex. 18 | colloidal silica*¹ | methyl acid phosphate | K₂HPO₄ | H₂O₂ | — | 2 | 1 | 1 |
| | 5.0% | 1.0% | 0.4% | 1.0% | | | | |
| Ex. 19 | colloidal silica*¹ | ethyl acid phosphate | K₂HPO₄ | H₂O₂ | — | 2 | 1 | 1 |
| | 5.0% | 1.0% | 0.4% | 1.0% | | | | |
| Ex. 20 | colloidal silica*¹ | ethyl glycol acid | K₂HPO₄ | H₂O₂ | — | 2 | 1 | 1 |
| | 5.0% | phosphate | 0.4% | 1.0% | | | | |
| | | 1.0% | | | | | | |
| Ex. 21 | colloidal silica*¹ | isopropyl acid | K₂HPO₄ | H₂O₂ | — | 2 | 1 | 1 |
| | 5.0% | phosphate | 0.4% | 1.0% | | | | |
| | | 1.0% | | | | | | |
| Ex. 22 | colloidal silica*¹ | phytic acid | K₂HPO₄ | H₂O₂ | — | 2 | 1 | 1 |
| | 5.0% | 1.0% | 0.4% | 1.0% | | | | |
| Ex. 23 | colloidal silica*¹ | 1-hydroxyethylidene- | K₂HPO₄ | H₂O₂ | — | 2 | 1 | 2 |
| | 5.0% | 1,1-diphosphonic acid | 0.4% | 1.0% | | | | |
| | | 1.0% | | | | | | |
| Ex. 24 | colloidal silica*¹ | orthophosphoric acid | K₂HPO₄ | H₂O₂ | citric acid | 1 | 1 | 2 |
| | 5.0% | 1.0% | 0.4% | 1.0% | 1.0% | | | |
| Ex. 25 | colloidal silica*¹ | metaphosphoric acid | K₂HPO₄ | H₂O₂ | citric acid | 1 | 1 | 1 |
| | 5.0% | 1.0% | 0.4% | 1.0% | 1.0% | | | |
| Ex. 26 | colloidal silica*¹ | orthophosphoric acid | K₂HPO₄ | H₂O₂ | maleic acid | 1 | 1 | 2 |
| | 5.0% | 1.0% | 0.4% | 1.0% | 1.0% | | | |
| Ex. 27 | colloidal silica*¹ | orthophosphoric acid | K₂HPO₄ | H₂O₂ | succinic acid | 1 | 1 | 2 |
| | 5.0% | 1.0% | 0.4% | 1.0% | 1.0% | | | |
| Ex. 28 | colloidal silica*¹ | orthophosphoric acid | K₂HPO₄ | H₂O₂ | malonic acid | 1 | 1 | 2 |
| | 5.0% | 1.0% | 0.4% | 1.0% | 1.0% | | | |
| Ex. 29 | colloidal silica*¹ | orthophosphoric acid | K₂HPO₄ | H₂O₂/ | malonic acid | 1 | 1 | 2 |
| | 5.0% | 1.0% | 0.4% | HClO₄ | 1.0% | | | |
| | | | | 1.0%/ | | | | |
| | | | | 2.0% | | | | |
| C. Ex. 1 | colloidal silica*¹ | orthophosphoric acid | K₂HPO₄ | — | — | 4 | 4 | 1 |
| | 5.0% | 1.0% | 0.4% | | | | | |
| C. Ex. 2 | colloidal silica*¹ | polyphosphoric acid | K₂HPO₄ | — | — | 4 | 4 | 1 |
| | 5.0% | 1.0% | 0.4% | | | | | |
| C. Ex. 3 | colloidal silica*¹ | orthophosphoric acid | — | H₂O₂ | — | 1 | 3 | 2 |
| | 5.0% | 1.0% | | 1.0% | | | | |
| C. Ex. 4 | colloidal silica*¹ | diphosphoric acid | — | H₂O₂ | — | 2 | 3 | 3 |
| | 5.0% | 1.0% | | 1.0% | | | | |
| C. Ex. 5 | colloidal silica*¹ | — | K₂HPO₄ | H₂O₂ | — | 4 | 4 | 1 |
| | 5.0% | | 0.4% | 1.0% | | | | |
| C. Ex. 6 | colloidal silica*¹ | — | K₂HPO₄ | H₂O₂ | citric acid | 2 | 1 | 3 |
| | 5.0% | | 0.4% | 1.0% | 1.0% | | | |
| C. Ex. 7 | colloidal silica*¹ | — | K₂HPO₄ | H₂O₂ | maleic acid | 2 | 1 | 3 |
| | 5.0% | | 0.4% | 1.0% | 1.0% | | | |
| C. Ex. 8 | colloidal silica*¹ | — | K₂HPO₄ | H₂O₂ | succinic acid | 2 | 1 | 3 |
| | 5.0% | | 0.4% | 1.0% | 1.0% | | | |
| C. Ex. 9 | colloidal silica*¹ | — | K₂HPO₄ | H₂O₂ | malonic acid | 2 | 1 | 3 |
| | 5.0% | | 0.4% | 1.0% | 1.0% | | | |
| C. Ex. 10 | colloidal silica*¹ | — | K₂HPO₄ | H₂O₂ | disodium | 3 | 2 | 3 |
| | 5.0% | | 0.4% | 1.0% | succinate/ | | | |
| | | | | | methanesulfonic | | | |
| | | | | | acid | | | |
| | | | | | 1.0%/1.0% | | | |
| C. Ex. 11 | colloidal silica*¹ | — | K₂HPO₄ | H₂O₂ | sulfuric acid | 1 | 2 | 4 |
| | 5.0% | | 0.4% | 1.0% | 1.0% | | | |
| C. Ex. 12 | colloidal silica*¹ | — | K₂HPO₄ | H₂O₂ | methanesulfonic | 2 | 2 | 4 |
| | 5.0% | | 0.4% | 1.0% | acid | | | |
| | | | | | 1.0% | | | |
| C. Ex. 13 | colloidal silica*¹ | phosphonobutane | K₂HPO₄ | H₂O₂ | — | 3 | 1 | 3 |
| | 5.0% | tricarboxylic acid | 0.4% | 1.0% | | | | |
| | | 1.0% | | | | | | |
| C. Ex. 14 | colloidal silica*¹ | phosphonobutane | — | H₂O₂ | — | 3 | 2 | 4 |
| | 5.0% | tricarboxylic acid | | 1.0% | | | | |
| | | 1.0% | | | | | | |

In the column entitled “Abrasive” in Table 1, “Colloidal silica*” denotes colloidal silica with an average particle size of 30 nm; “Colloidal silica*²” denotes colloidal silica with an average particle size of 50 nm; and “Colloidal silica*³” denotes colloidal silica with an average particle size of 10 nm. These average particle sizes were determined from a specific surface area measured by a BET method. In the column entitled “Salt” in Table 1, “K₂HPO₄” represents dipotassium hydrogenphosphate and “Na₂HPO₄” represents disodium hydrogenphosphate. In the column entitled “Oxidizing agent” in Table 1, “H₂O₂” represents hydrogen peroxide, and “HClO₄” represents perchloric acid.

What the results in Table 1 indicate is summarized below.

In Examples 1 to 29, any of the evaluations on polishing rate, scratches, and corrosiveness is either excellent or good. The results suggest that any polishing composition of Examples 1 to 29 has high polishing ability and high passive film-forming ability.

The polishing rate determined using any of the polishing compositions of Examples 1 to 29 is greater than the polishing rate determined using the polishing composition of either Comparative Example 13 or 14 containing phosphonobutane tricarboxylic acid. The results suggest that specific acids such as orthophosphoric acid contribute in improving polishing ability of a polishing composition greater than the degree that an organic phosphoric acid, such as phosphonobutane tricarboxylic acid, does.

The polishing rate determined using the polishing composition of Example 25 containing a polishing accelerator is greater than the polishing rate determined using the polishing composition of Example 16 containing no polishing accelerators. The result suggests that polishing ability of a polishing composition is enhanced by addition of a polishing accelerator.

The polishing rate determined using the polishing composition of Comparative Example 1 or 2 containing no oxidizing agents is less than the polishing rate determined using the polishing composition of Example 2 or 15 containing an oxidizing agent. The result suggests that the polishing ability of a polishing composition is enhanced by addition of an oxidizing agent.

The evaluation for scratches determined using the polishing composition of Comparative Example 3 or 4 containing no specific salts is poor compared with the evaluation for scratches determined using the polishing composition of Example 2 or 14 containing a specific salt. The result suggests that a specific salt contributes to an improvement of surface characteristics of the polished substrate.

The polishing rate determined using the polishing composition of Comparative Example 5 containing no specific acids is less than the polishing rate determined using any of the polishing compositions of Examples 1 to 3 and 14 to 23 containing a specific acid. The result suggests that polishing ability of a polishing composition is enhanced by addition of a specific acid.

The polishing rate determined using any of the polishing compositions of Comparative Examples 6 to 12 containing a polishing accelerator but no specific acids is greater than the polishing rate determined using the polishing composition of Comparative Example 5 containing neither polishing accelerators nor specific acids. However, the evaluation for corrosiveness determined using any of the polishing compositions of Comparative Examples 6 to 12 is not good, being ranked either as acceptable or poor.

1. A polishing composition comprising:
an abrasive containing a silicon oxide;
at least one acid selected from the group consisting of orthophosphoric acid, diphosphoric acid, polyphosphoric acid, metaphosphoric acid, hexametaphosphoric acid, methyl acid phosphate, ethyl acid phosphate, ethyl glycol acid phosphate, isopropyl acid phosphate, phytic acid, and 1-hydroxyethylidene-1,1-diphosphonic acid;
at least one salt selected from the group consisting of sodium salts, potassium salts, and lithium salts of an acid selected from orthophosphoric acid, diphosphoric acid, polyphosphoric acid, metaphosphoric acid, hexametaphosphoric acid, methyl acid phosphate, ethyl acid phosphate, ethyl glycol acid phosphate, isopropyl acid phosphate, phytic acid, and 1-hydroxyethylidene-1,1-diphosphonic acid;
an oxidizing agent; and
water.

2. The polishing composition according to claim 1, wherein the at least one acid is orthophosphoric acid or polyphosphoric acid.

3. The polishing composition according to claim 1, wherein the at least one salt is a sodium salt or a potassium salt of the acid.

4. The polishing composition according to claim 1, further comprising a polishing accelerator, which contains at least one compound selected from the group consisting of citric acid, maleic acid, maleic anhydride, malic acid, glycolic acid, succinic acid, itaconic acid, malonic acid, iminodiacetic acid, gluconic acid, lactic acid, mandelic acid, tartaric acid, crotonic acid, nicotinic acid, acetic acid, adipic acid, glycine, alanine, histidine, formic acid, and oxalic acid.

5. The polishing composition according to claim 1, wherein the abrasive is colloidal silica.

6. The polishing composition according to claim 1, wherein the oxidizing agent is hydrogen peroxide.

7. The polishing composition according to claim 1, wherein the pH of the polishing composition is 0.5 to 5.

8. The polishing composition according to claim 1, wherein the polishing composition is used for polishing a substrate for a magnetic disk.

9. A method for polishing an object, the method comprising:
preparing a polishing composition including:
an abrasive containing a silicon oxide;
at least one acid selected from the group consisting of orthophosphoric acid, diphosphoric acid, polyphosphoric acid, metaphosphoric acid, hexametaphosphoric acid, methyl acid phosphate, ethyl acid phosphate, ethyl glycol acid phosphate, isopropyl acid phosphate, phytic acid, and 1-hydroxyethylidene-1,1-diphosphonic acid;
at least one salt selected from the group consisting of sodium salt, potassium salt, and lithium salt of an acid selected from orthophosphoric acid, diphosphoric acid, polyphosphoric acid, metaphosphoric acid, hexametaphosphoric acid, methyl acid phosphate, ethyl acid phosphate, ethyl glycol acid phosphate, isopropyl acid phosphate, phytic acid, and 1-hydroxyethylidene-1,1-diphosphonic acid;
an oxidizing agent; and
water; and
polishing the object using the prepared polishing composition.

10. The method according to claim 9, wherein the object is a substrate for a magnetic disk.
